(19) United States
(12) Patent Application Publication
(10) Pub. No.: US 2009/0282131 A1
(43) Pub. Date: Nov. 12, 2009

(54) Medical system architecture

(76) Inventor: Michael Maschke, Lonnerstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/437,635

(22) Filed: May 8, 2009

Related U.S. Application Data
(60) Provisional application No. 61/051,704, filed on May 9, 2008.

(51) Int. Cl. G06F 15/177

(52) U.S. Cl. 709/220

(57) ABSTRACT

A medical system architecture with a communication network for data transmission for a better and more comprehensive diagnosis of patients is provided. The medical system architecture includes at least one first modality for acquiring in-vivo examination images, a processing apparatus assigned to the modality for processing the examination images, a transmission apparatus for transmitting the examination images, at least one second modality for acquiring in-vitro examination data, a processing facility assigned to the second modality for processing the examination data and a transmission apparatus for transmitting the examination data, and at least one storage apparatus for storing the examination images and the examination data.

### CROSS REFERENCE TO RELATED APPLICATIONS

The present application claims the benefit of a provisional patent application filed on May 9, 2008, and assigned application No. 61/051,704, which is incorporated by reference herein in its entirety.

### FIELD OF THE INVENTION

The invention relates to a medical system architecture with a communication network for data transmission.

### BACKGROUND OF THE INVENTION

Within the field of medicine, the diagnosis and therapy of many diseases is assisted by in-vivo examinations, in other words examinations with the aid of imaging apparatuses. Examples of this are examinations using angiography x-ray systems, magnetic resonance tomographs or positron emission tomographs. In addition, in-vitro examinations are also needed in the majority of cases, i.e. laboratory tests on tissues, blood and other body fluids. To this end, body fluid has to be removed from the patient and send via a messenger, e.g. by means of medical personal or with the aid of a pneumatic tube system, to the diagnostic laboratory. The body fluid is analyzed there and the laboratory result is communicated to the diagnostic or therapeutic department by way of telephone or fax.

To simplify access to information from different in-vivo examinations, some models currently exist which connect a number of imaging apparatuses in a data network. Such a network is known for instance from DE 100 31 779 A1.

A DNA analyzer operated in a data network is known in the document U.S. Pat. No. 5,776,767.

### SUMMARY OF THE INVENTION

It is the object of the present invention to improve and simplify the role of established medical diagnosis in respect of a patient.

The object is achieved in accordance with the invention by a medical system architecture comprising a communication network for data transmission according to independent claim; advantageous configurations of the invention form the subject matter of the associated subclaims.

The invention creates a comprehensive communication network, which connects all modalities which can be used for a diagnosis in order to be able to achieve a well-founded, more rapid and precise diagnosis. The inventive communication network connects both in-vivo modalities as well as in-vitro modalities, so that image data obtained directly on the patient can be rapidly and easily supplemented and compared with laboratory and analysis data. A less error-prone, more comprehensive and more well-founded diagnosis of a patient is possible in this way. Furthermore, there is no longer any need to manage several separate networks, thereby also saving on labor. All connected modalities and apparatuses can access data stored uniquely in the communication network, multiple entries are unnecessary. A communication network of this type can be arranged in particular in a hospital with an associated laboratory area.

The inventive communication network comprises
at least one first modality for acquiring in-vivo examination images, a processing apparatus assigned to the modality for processing the examination images and a transmission apparatus for transmitting examination images,
at least one second modality for acquiring in-vitro examination data, a processing apparatus assigned to the modality for processing the examination data and a transmission apparatus for transmitting the examination data,
at least one storage apparatus for storing the examination images and/or the examination data, as well as
at least one further post-processing apparatus for post-processing the examination images and/or the examination data.

According to one embodiment of the invention, the processing apparatuses assigned to the modalities operate according to the DICOM method for exchanging data between different application programs. Data exchange is facilitated significantly as a result of all data being converted into a general standardized data format.

A data archiving system, in particular a PACS (Picture Archiving and Communication System) is advantageously also available. Data for archiving both in-vivo modalities (and/or their processing or transmission apparatuses) as well as in-vitro modalities (and/or their processing or transmission apparatuses) can be sent to the PACS.

According to a further embodiment of the invention, at least one server also exists for the common storage of the examination images and the examination data.

The IT infrastructures (IT: Information Technology) for the in-vivo and in-vitro diagnostics were previously separated from one another, this being disadvantageous in that at least two IT infrastructures have to be maintained and serviced and the information needed to treat the patient does not exist completely overall and a large amount of data has to be input multiple times.

The invention enables in-vivo and in-vitro diagnostics to be connected to a common data network comprising a common information system. This can be a wired or wireless network, which is realized with the aid of internet/Ethernet technology and/or LAN or Bluetooth technology. To this end, IEEE 802 standards can be used.

The first modalities for acquiring in-vivo examination images may include all current imaging apparatuses and the combinations thereof, e.g. x-ray systems for projection radiography, fluoroscopy systems, angiographic x-ray apparatuses, cardiological x-ray apparatuses, computed tomography apparatuses, positron emission tomography apparatuses, SPECT apparatuses (SPECT: Single-Photon-Emission-Computer-Tomography), magnetic resonance tomography apparatuses, ultrasound apparatuses, optical endoscopes, optical coherence tomography apparatuses, linear accelerators, proton therapy apparatuses.

According to one embodiment of the invention, several first modalities for acquiring in-vivo examination images with assigned processing apparatuses and transmission apparatuses are available, said modalities being connected to one another in a sub communication network for data exchange purposes.

The second modalities for acquiring in-vitro examination data can consist for instance of the following analysis and laboratory apparatuses: apparatuses for immunodiagnostics, molecular diagnostics, e.g. bio and gene markers, DNA-und protein analyzers, HIV, hepatitis, clinical-chemical diagnostics, hematology, blood gas diagnostics, diabetes diagnostics, urine analysis. Various examinations, e.g. of blood values, enzyme markers, cardiac markers, markers for strokes, cardiac infarction, atherosclerotic plaques etc. can thus be implemented.

According to a further embodiment of the invention, several second modalities for acquiring in-vitro examination data using assigned processing apparatuses and transmission apparatuses are available, said modalities being connected to one another in a sub communication network for data exchange purposes.

The communication network enables organs, bones, metabolisms and vessels to be recorded, as well as analysis and laboratory values from tissue and body fluid examinations to be registered, displayed, recalled and compared with one another.

In a further embodiment, additional information can be evaluated in the medical communication system, e.g. physiological, demographic and administrative data relating to the patient or billing data with the health insurance company. Furthermore, medical results can be created, considered and processed. To this end, at least one processing apparatus, for instance a PC or server, is connected to the communication network, upon which processing apparatus the physiological, demographic and administrative data are stored. Corresponding software for processing the data is likewise available.

A network interface for public networks, e.g. telecommunication, DLS (Digital Subscriber Line) and WLAN (Wireless Local Area Network) may also be available. Patient information can thus be made available, if necessary, to other medical facilities, e.g. in the event of a continuing treatment of the patient. Furthermore, a network interface for maintaining in-vivo and in-vitro modalities may also be available from the manufacturer, e.g., by means of the remote service method and/or the preventive maintenance method (preventative maintenance of a system by way of remote control). This can either be a direct connection of the respective modality or an indirect connection by way of an interconnected service router arranged in the communication network in the clinic.

The invention is also advantageous in that it brings about a cost optimization and facilitates the examination of patients.

### BRIEF DESCRIPTION OF THE DRAWINGS

The invention and further advantageous configurations according to the features of the subclaims are explained in more detail below with reference to schematically illustrated exemplary embodiments in the drawing, without the invention being restricted to these exemplary embodiments as a result, in which;

FIG. 1 shows a view of an inventive communication network;

FIGS. 2 and 3 show views of inventive communication networks with in-vivo modalities in a first subnetwork and in-vitro modalities in a second subnetwork;

FIGS. 4 and 5 show views of additional inventive communication networks with in-vivo modalities and in-vitro modalities.

### DETAILED DESCRIPTION OF THE INVENTION

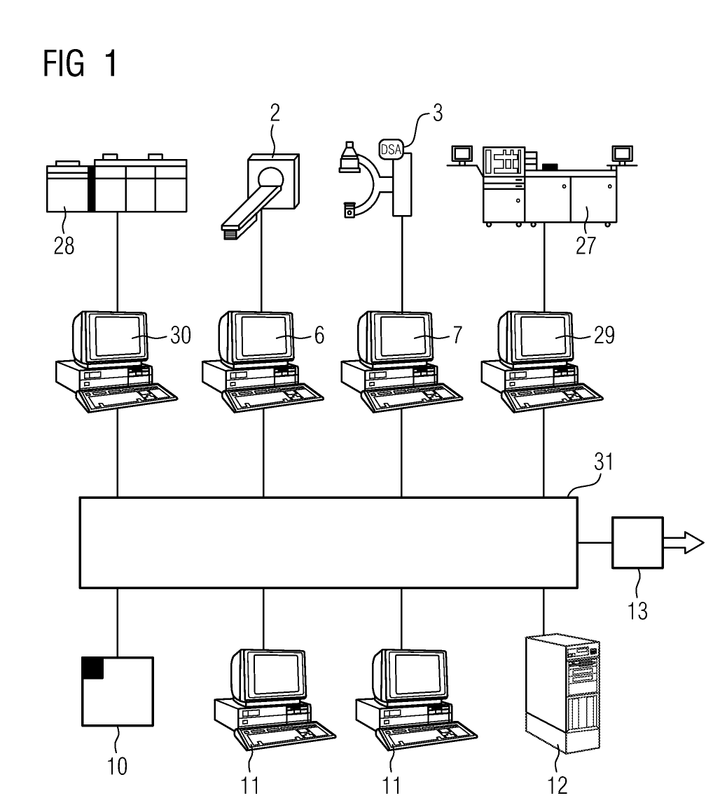

The system architecture of a medical communication network 31 is shown by way of example in FIG. 1. In-vivo modalities and also in-vitro modalities are connected to the communication network. The in-vivo modalities 2 and 3 are used to acquire medical images, said modalities 2 and 3 comprising an MR unit 2 for magnetic resonance and a DSA unit 3 for digital subtraction angiography as image-generating systems for instance. Control panels 6 and 7 of the modalities or workstations are connected to the in-vivo modalities 2 and 3, with which control panels the acquired medical images can be processed and stored locally. Patient data belonging to the images can also be entered. The in-vitro modalities 27 and 28, which comprise an immunodiagnostics system 27 and a clinical chemistry system 28, are used to acquire analytical in-vitro examination data. Control panels 29 and 30 of the modalities or workstations are connected to the in-vitro modalities 27 and 28, with which the acquired medical in-vitro data can be processed and locally stored. Patient data belonging to the data can also be entered here.

The control panels 2, 3, 29 and 30 are connected to a communication network 31 as LAN/WAN Backbone for distributing the generated images, data and communication. The images generated in the modalities 2, 3, 27 and 28 and the images and data further processed in the control panels 6, 7, 29 and 30 can thus be stored in central storage and archiving systems 10 for instance or can be routed to other workstations.

Further viewing workstations 11 are connected to the communication network 31 as reporting consoles, which comprise local storage devices. A viewing workstation 11 of this type is a very quick microcomputer based on one or several rapid processors for instance. In the viewing workstations 11, the acquired images and data stored in the archiving system can subsequently be called up for clinical trials and stored in the local memory, which can be made immediately available to the reporting person working at the viewing workstation 11.

Servers, for instance patient data servers (PDS), file servers, program servers and/or EPR servers are also connected to the communication network 31.

Images and data can be exchanged here by way of the communication network 31 in accordance with the DICOM standard (Digital Imaging and Communication in Medicine), an industry standard for transmitting images and further medical information between computers, so that digital communication is possible between diagnosis and therapy devices as well as laboratory and analysis devices from different manufacturers. A network interface 13 can be connected to the communication network 31, by way of which the internal communication network 31 is connected to a global data network, for instance the World Wide Web, so that the standardized data can be exchanged with different networks worldwide.

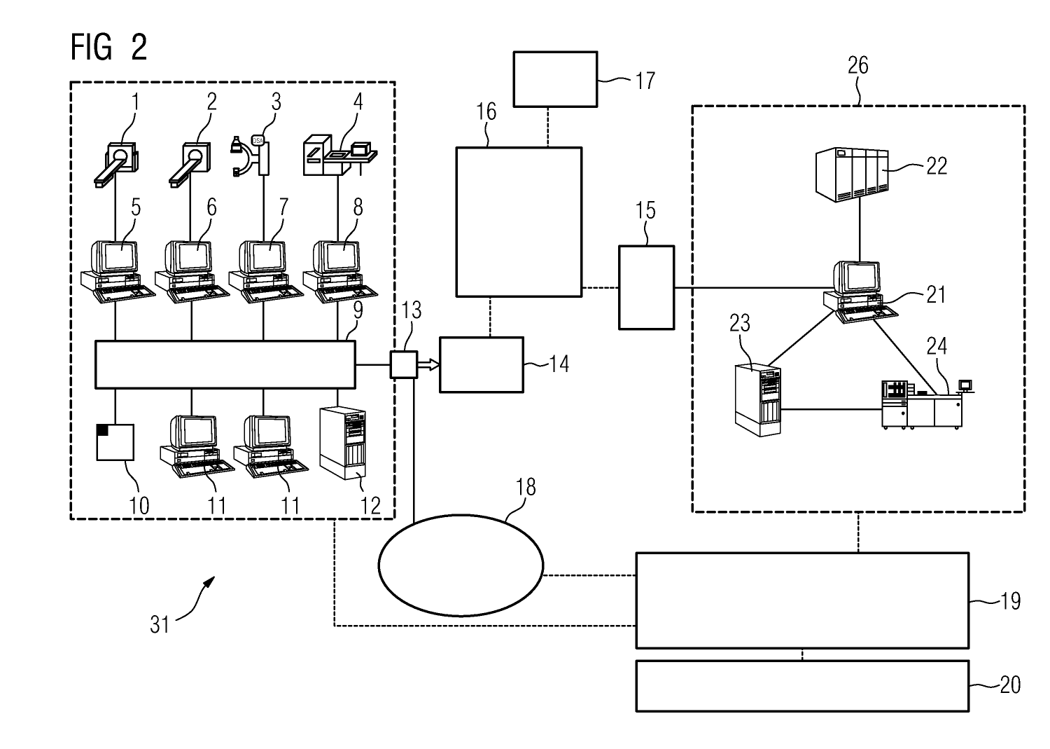

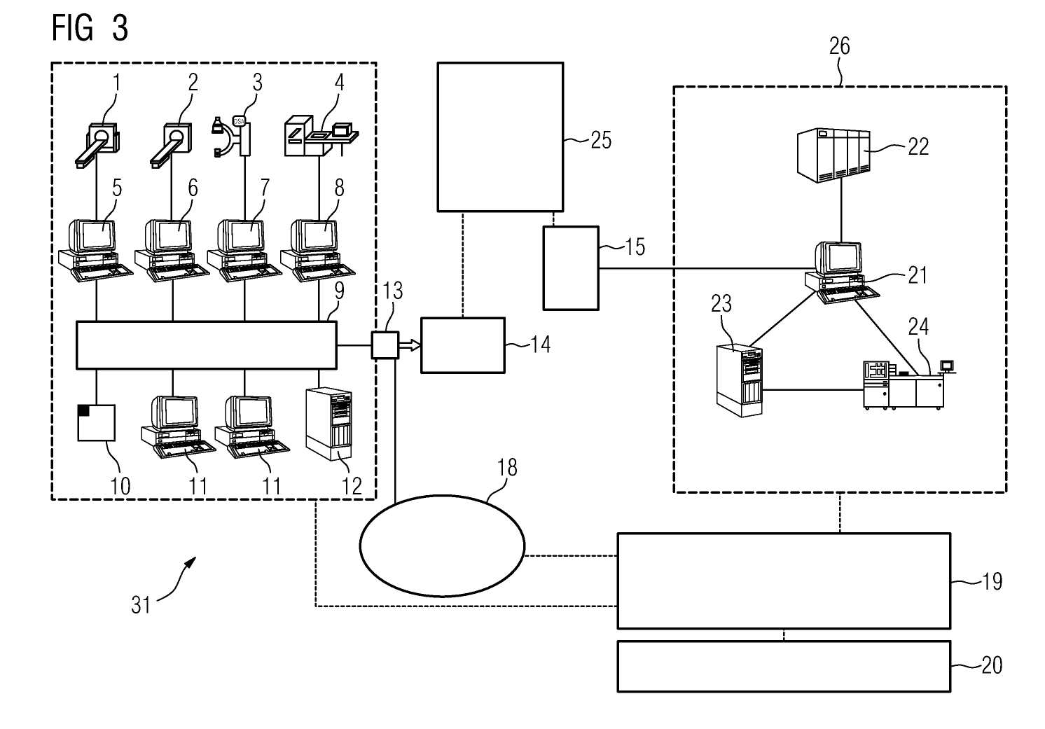

FIGS. 2 and 3 show further embodiments of the invention, in which two different sub communication networks are connected with one another to form an overall communication network, with the first sub communication network 9 containing all in-vivo modalities and the second sub communication network 26 comprising all in-vitro analysis and laboratory devices. Such an embodiment is particularly advantageous if two sub communication networks are already present and these only have to be connected.

The first sub communication network 9 of all in-vivo modalities for detecting medical images comprises for instance a CT unit 1 for computed tomography, an MR unit 2 for magnetic resonance, a DSA unit 3 for digital subtraction angiography and an x-ray unit 4 for digital radiography 4, to which in-vivo modalities 1 to 4 are connected control panels 6 to 8. The control panels 5 to 8 are connected to the sub communication network 9 as LAN/WAN Backbone for distributing the generated images and communication. Storage and archiving systems 10, viewing workstations 11 and servers 12 can be connected. Images and data can be exchanged by way of the image communication network 9 according to the DICOM standard.

The second sub communication network 26, for instance an ADVIA CentraLink® network, has several in-vitro analysis and laboratory devices 24, a LIS (Laboratory's Information System) 22, an ADVIA CentraLink® Server 21 and a ADVIA WorkCell/LabCell® control panel 23. The ADVIA CentraLink® network 26 manages the patient, analysis and quality control data of up to 16 analysis and laboratory devices 24. The ADIVA CentralLink® Server 21 controls and regulates the data communication between the individual units within the ADVIA CentraLink® network and work orders, demographic patient data, analysis data of the patient and billing data of all connected units is managed and archived in the LIS 22. The analysis and laboratory devices 24 are used to examine and evaluate samples such as body fluids, cell and tissue samples of living beings. The evaluation of the samples contains inter alia the medical/clinical chemical compositions, biological and physical components, e.g. blood gas and enzyme values or genetic data. The distribution and management of the samples is automatically optimized on the different analysis and laboratory devices 24 by way of the ADVIA WorkCell/LabCell® control panel 23.

The two sub communication networks are connected to form a common communication network, with a network interface 13 and respective translators 14 and 15 possibly being present, which translate the respective data protocols. A first translator 14 translates the DICOM protocol into network protocols of the analysis and laboratory data network and a second translator 15 translates the network protocols of the analysis and laboratory data network into DICOM protocols, so that the bidirectional communication is possible without any problem. At least one data server 16 for common data, such as demographic patient data as well as at least one associated data memory 17 for common data is also located in the common communication network (FIG. 2) and/or an exchange server 25 with a data filter (FIG. 3). The communication network also comprises a PACS network 18, which similarly functions according to the DICOM standard and a remote service interface 19. The remote service interface 19 enables a connection to an external interface 20, e.g. with the manufacturer of the modalities or another hospital.

In the viewing workstations 11, the images and data stored in the common data server 16 and data memory 17 and in the storage systems and modalities of the respective sub communication networks or in the PACS network 18 can be called up at any time for clinical trials, so that it can be immediately available to a reporting person working at the viewing workstation 11 or another control panel located in the sub communication network. Therefore, laboratory and analysis data which is already stored directly during an examination with one of the in-vivo modalities can also be called up from the laboratory and analysis data network and can contribute to the diagnosis.

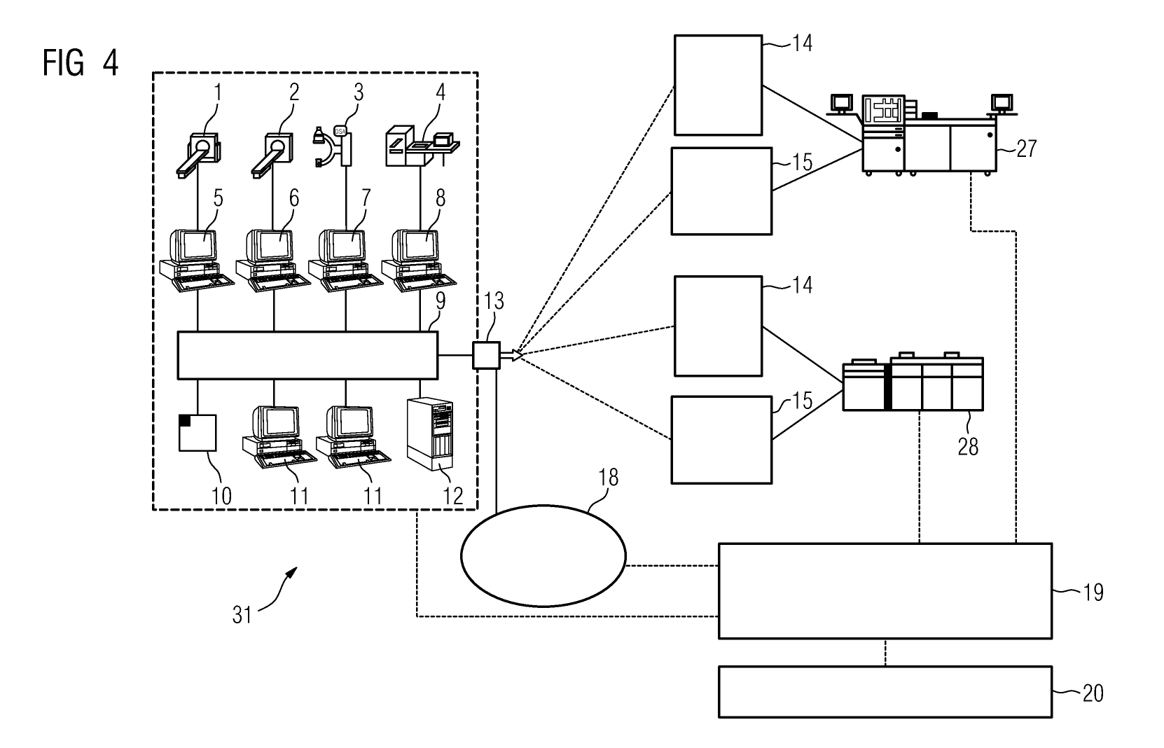

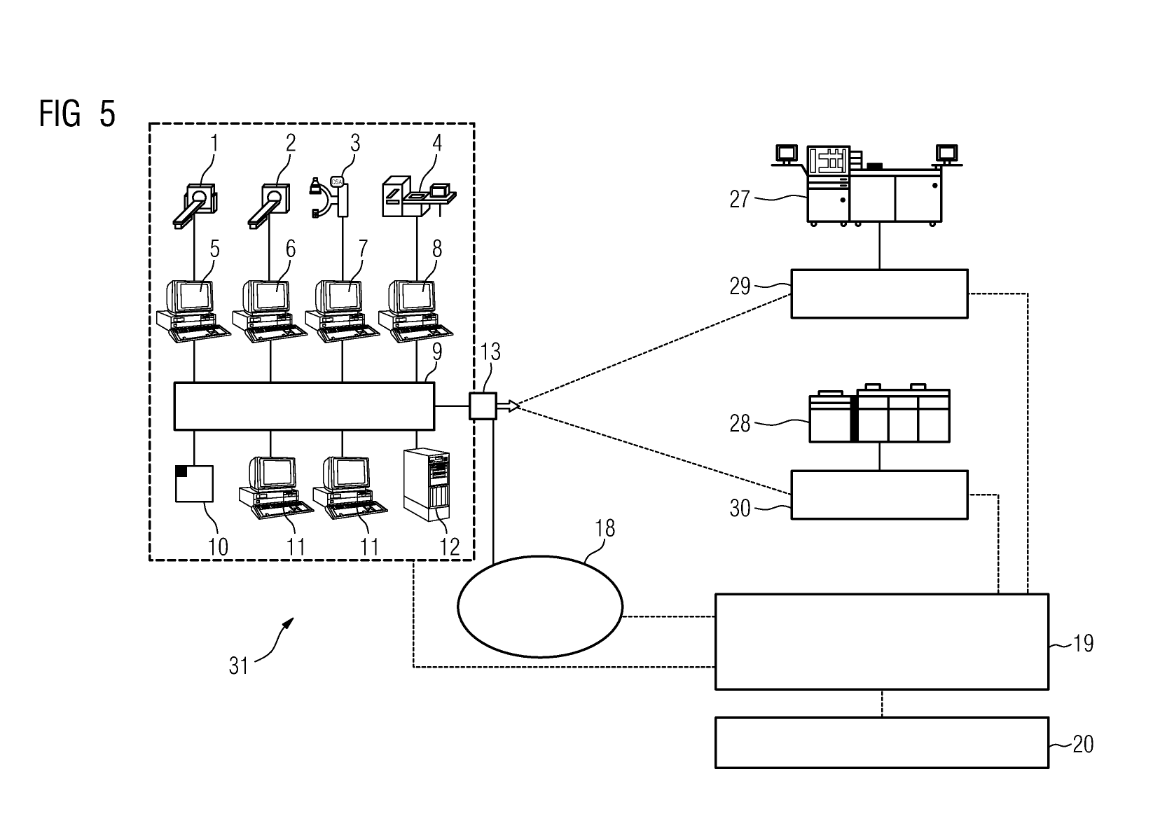

FIGS. 4 and 5 show further embodiments of the invention, in which a first in-vivo sub communication network 9 as well as individual laboratory and diagnosis devices are present and are connected to form a communication network. The first sub communication network 9 is connected in each instance to the in-vitro modalities 27 and 28, which are formed for instance by an immunodiagnostic system 27 and a clinical chemistry system, with each translator 14 and 15 (FIG. 4) and/or control panel 29 and 30 (FIG. 5) being connected intermediately to the DICOM protocol function. All data and images can in turn be accessed from every point of the communication network.

The modalities can preferably be connected via a wired network to the internet/Ethernet technology (e.g. TCP/IP=Transmission Control Protocol/internet Protocol., VPN=Virtual Private Network). The following standards can be used for instance: IEEE 802.1 (Logical Link Control), IEEE 802.3 (10 base 2, 10 Base 5), IEEE 802.3i (10 BaseT, 100 BaseT, 100 BaseT), IEEE 802.4 (Token Bus), IEEE 802.5 (Token Ring), IEEE 802.6 (Metropolitan Area), IEEE 802.7 (Broadband), IEEE 802.8 (Fiber Optic), IEEE 802.9 (Isochronous LAN), IEEE 802.10 (Security), IEEE 802.12 (Demand Priority), IEEE 802.14 (Cable Modem), IEEE 802.17 (Resilient Packet Ring), FDDI/ISO 9314 (Double ring), ATM (intermeshed), Fiber UTP/STP.

To exchange image, analysis and laboratory data, the in-vivo and in-vitro modalities can preferably be connected to the Wireless LAN or Bluetooth technologies by way of a wired network. The following standards can be used for instance: IEEE 802.11, IEEE 802.11b, IEEE 802.15 (Personal Area), IEEE 802.16 (Broadband).

The in-vivo modalities can consist of the following imaging devices or a combination of these devices: x-ray systems for projection radiography, fluoroscopy systems (upper or lower couch), angiographic x-ray apparatuses, cardiological x-ray apparatuses, computed tomographs, PET, SPECT, PET/CT, SPECT/CT, MRI, ultrasound apparatuses, optical endoscopes, OCT apparatuses, linear accelerators, proton therapy apparatus, robot-based forms of the above apparatuses.

The in-vitro modalities may consist for instance of the following analysis and laboratory apparatuses: apparatus for immunodiagnostics (e.g. immunoassay), apparatus for molecular analysis (e.g. bio-und gene markers, DNA-und protein analyzers, HIV, hepatitis), apparatus for clinical chemistry analysis, apparatus for hematology analysis, apparatus for analyzing blood gases, diabetes, urine analysis, lab Automation, Near Patient Testing, e.g. using Lab-on-a-Chip.

The communication network allows the following examinations and analyses to be carried out for instance:

Recordings of organs, bones, metabolisms and vessels can be recorded, illustrated, stored and recalled.

Analysis and laboratory values from biological tissue and lymph can also be shown, recorded, stored and recalled simultaneously, for instance inter alia
blood values such as blood gas, blood sugar, composition of the corpuscles, clotting factors,
enzyme markers to show a cardiac infarction such as overall creatinine phosphokinase (CPK), MB-fraction, MB2-fraction, troponin I and T und B-natural protein, myoglobin, cTn1, CK-MB
new cardiac markers such as h-FABP (cardiac fatty acid bonding protein in the blood), sCD40L, MPO (myeloperoxidase), BNP (natriuretic peptide), NT-pro BNP, D-Dimer, CRP, biopolymer marker made of Amino Acid 2 to 13 SEQ ID No: 1, biopolymer marker ID SKITHRIHWESASLL
markers for a stroke such as serum phosphoglycerate mutase B-Type isozyme, S-100b (marker for astrocyte activity), B-type neurotropic growth factor, metalloproteinases-9 matrix, monocyte chemotactic protein-1, biopolymer marker made of amitio acid 2 to 13 SEQ ID No: 1, combinations markers made of 4 sub markers (myelin protein, β-isoform of S 100-protein, neuron-specific enolase, endothelial cell membrane protein), biopolymer marker ID SKITHRIHWESASLL
Inflammation marker for atherosclerotic plaque such as C-reactive protein (CRP), fibrinogen

Gene tests for identifying high-risk patients, for instance for cardio-vascular diseases, diabetes mellitus and strokes can also be implemented, for instance
for cardiac infarction: ApoB Arg3500Gln, ApoB Arg3531 Cys, ApoE E2, E3, E4, MTHFR Ala22Val, PAI-1 4G/5G, LPL Asn291Ser, ACE 287 bp I/D in intron 16, angiotensinogen Met235Thr, CETP B1/B2, Cyp 7A1 −204A>C, paraoxonase 1 Gln192Arg, glycoprotein III PLA1/A2
stroke: lysyl oxidase
atherosclerotic plaque: Lp-LPA2=lipoprotein-associated phospolipase A2>risk of cardiac infarction ischemic stroke, Lp (a)=senum lipoprotein a

Further markers and diseases are naturally likewise covered by the invention.

In a further embodiment, physiological (e.g. from patient monitors or heart catheter measuring stations), demographic and administrative data relating to the patient as well as medically-relevant billing data (e.g. with the health insurance company) and medical trials can also be created, observed and managed in the medical communication network; to this end, a further apparatus can be provided and connected to the communication network.

An interface for public data networks (e.g. telecommunication, DSL, W-LAN) may also be available, in order, if necessary, to make this information available to other medical facilities, e.g. in the case of continuing treatment to the patient.

An interface may also exist, by way of which a remote service and/or preventative maintenance of the manufacturer of the modalities is possible on the in-vivo and in-vitro modalities. Here either direct remote connections of the respective modality or indirect remote connections can be used via a interconnected service router in the respective hospital.

The invention can be summarized briefly as below: for a better and more comprehensive diagnosis of patients, a medical system architecture comprising a communication network is provided for data transmission, comprising
at least one first modality for acquiring in-vivo examination images, a processing apparatus assigned to the modality for processing the examination images and a transmission apparatus for transmitting the examination images,
at least one second modality for acquiring in-vitro examination data, a processing apparatus assigned to the modality for processing the examination data and a transmission apparatus for transmitting the examination data and
at least one storage apparatus for storing the examination images and/or the examination data.

1-12. (canceled)

13. A medical system architecture with a communication network for data transmission, comprising:
a first modality for acquiring an in-vivo examination image of a patient;
a first processing apparatus assigned to the first modality for processing the examination image;
a first transmission apparatus assigned to the first modality for transmitting the examination image;
a second modality for acquiring in-vitro examination data of the patient;
a second processing apparatus assigned to the second modality for processing the examination data;
a second transmission apparatus assigned to the second modality for transmitting the examination data; and
a storage apparatus for storing the examination image and the examination data.

14. The medical system architecture as claimed in claim 13, further comprising a post-processing apparatus for post-processing the examination image and the examination data.

15. The medical system architecture as claimed in claim 13, wherein the first and the second processing apparatuses operate according to Digital Imaging and Communication in Medicine method for exchanging data between different application programs.

16. The medical system architecture as claimed in claim 13, further comprising a plurality of first modalities for acquiring a plurality of in-vivo examination images of the patient with assigned first processing apparatuses and first transmission apparatuses.

17. The medical system architecture as claimed in claim 16, wherein the plurality of the first modalities are connected to one another in a first sub communication network for data exchange.

18. The medical system architecture as claimed in claim 13, further comprising a plurality of second modalities for detecting a plurality of in-vitro examination data of the patient with assigned second processing apparatuses and second transmission apparatuses.

19. The medical system architecture as claimed in claim 18, wherein the plurality of the second modalities are collected to one another in a second sub communication network for data exchange.

20. The medical system architecture as claimed in claim 13, further comprising a data archiving system.

21. The medical system architecture as claimed in claim 13, further comprising a server for commonly storing the examination image and the examination data.

22. The medical system architecture as claimed in claim 13, wherein the communication network comprises wired and wireless communication lines.

23. The medical system architecture as claimed in claim 13, wherein the communication network comprises a translator for translating data formats between the first and the second modalities.

24. The medical system architecture as claimed in claim 13, wherein the communication network comprises a remote service interface.

25. The medical system architecture as claimed in claim 13, wherein the communication network comprises an interface for communication with an external network.

26. The medical system architecture as claimed in claim 13, wherein the communication network comprises an apparatus for acquiring physiological data of the patient.

27. A method for data transmission in a medical system architecture with a communication network, comprising:
providing a first modality for acquiring an in-vivo examination image of a patient;
assigning a first processing apparatus to the first modality for processing the examination image;
assigning a first transmission apparatus to the first modality for transmitting the examination image;
providing a second modality for acquiring in-vitro examination data of the patient;
assigning a second processing apparatus to the second modality for processing the examination data;
assigning a second transmission apparatus to the second modality for transmitting the examination data; and
storing the examination image and the examination data.
